(19) United States
(12) Patent Application Publication
(10) Pub. No.: US 2024/0143301 A1
(43) Pub. Date: May 2, 2024

(54) Automated Deployment and Management of Network Functions in Multi-Vendor Cloud Networks

(71) Applicant: AT&T Intellectual Property I, L.P., Atlanta, GA (US)

(72) Inventors: Peter Jon Adams, Hoover, AL (US); Marius Gudelis, Holmdel, NJ (US); Kiran Panja, Bellevue, WA (US); Johnny Chen, Bellevue, WA (US); Qun Ren, Bellevue, WA (US)

(73) Assignee: AT&T Intellectual Property I, L.P., Atlanta, GA (US)

(21) Appl. No.: 17/978,435

(22) Filed: Nov. 1, 2022

(51) Int. Cl. G06F 8/61; G06Q 10/06

(52) U.S. Cl. CPC G06F 8/61; G06Q 10/06315

(57) ABSTRACT

The concepts and technologies disclosed herein are directed to automated deployment and management of network functions in multi-vendor cloud networks. A service provider system can create at least one repository structure to hold at least one pipeline, at least one artifact, at least one image, and code used to create a network function defined by a vendor. The service provider system can create a secrets management structure for the network function. The service provider system can define a schema to support environment variables for a network function type of the network function. The service provider system can create instance specific data to satisfy the schema required for the network function type and can store the at least one artifact into a framework defined during a design phase. The service provider system can instruct the at least one repository structure to exhibit version control and change management behavior.

### BACKGROUND

In a multi-vendor cloud network, each vendor has its own method for deploying network functions. This can lead to as many different network function deployment solutions as there are vendors, which makes automating deployments challenging for service providers. In a multi-vendor cloud network, for example, there may be hundreds of instances of each vendor's network functions. To keep pace with the rate of deployments, upgrades, and management at this scale requires a common automation solution. Moreover, there are different types of deployment environments in a multi-vendor cloud network to serve different operational needs. Service providers should manage these different deployment environments to support operational needs such as promotion from vendor laboratory to service provider laboratory and from service provider laboratory to production. Another challenge for a service provider is to standardize vendor deliveries and to clearly define the integration methodology and interface in the context of network function deployment and lifecycle management.

### SUMMARY

The concepts and technologies disclosed herein are directed to automated deployment and management of network functions in multi-vendor cloud networks. A service provider system can create at least one repository structure to hold at least one pipeline, at least one artifact, at least one image, and code used to create a network function defined by a vendor. The service provider system can receive a package including a bill of materials, the at least one pipeline, the at least one artifact, the at least one image, and the code. The package can be received from a vendor that provides the network function. The service provider system can create a secrets management structure for the network function. The service provider system can define a schema to support environment variables for a network function type of the network function. The service provider system can create instance specific data to satisfy the schema required for the network function type and can store the at least one artifact into a framework defined during a design phase. The service provider system can instruct the at least one repository structure to exhibit version control and change management behavior. The service provider system can present a graphical user interface (“GUI”)-based tool through which a user can instruct the service provider system to deploy the network function.

In some embodiments, the network function is or includes a virtual network function (“VNF”). The VNF can be hosted on a network functions virtualization architecture. In other embodiments, the network function is or includes a containerized network function (“CNF”). The CNF can be hosted on a containerized cloud architecture.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a block diagram illustrating aspects of an illustrative operating environment in which aspects of the concepts and technologies disclosed herein can be implemented.

FIG. 2 is a block diagram illustrating aspects of another illustrative operating environment in which aspects of the concepts and technologies disclosed herein can be implemented.

FIG. 3 is a flow diagram illustrating aspects of a method for implementing a common deployment framework during a design phase, according to an illustrative embodiment.

FIG. 4 is a flow diagram illustrating aspects of a method for implementing a common deployment framework during an execution phase, according to an illustrative embodiment.

FIG. 5 is a block diagram illustrating an exemplary containerized cloud architecture capable of implementing, at least in part, aspects of the concepts and technologies disclosed herein.

FIG. 6 is a block diagram illustrating an exemplary network functions virtualization architecture and components thereof capable of implementing, at least in part, aspects of the concepts and technologies disclosed herein.

FIG. 7 is a block diagram illustrating an exemplary computer system capable of implementing, at least in part, aspects of the concepts and technologies disclosed herein.

FIG. 8 is a block diagram illustrating an exemplary network capable of implementing, at least in part, aspects of the concepts and technologies disclosed herein.

### DETAILED DESCRIPTION

In a multi-vendor cloud network, each vendor has its own method for deploying network functions. This can lead to as many different network function deployment solutions as there are vendors, which makes automating deployments challenging for service providers. By developing a common methodology and framework for deployment and management of network functions, the concepts and technologies disclosed herein can simplify the operations of a multi-vendor cloud network and can provide automation to further assist with the speed and accuracy of deployments and configuration upgrades. Automating a common solution is easier than trying to automate “N” different vendor solutions. A common deployment and management methodology is especially powerful in a containerized network function (“CNF”) environment because containers provide portability of applications from vendor development environments to service provider laboratory and production environments. Moreover, by leveraging industry standard Continuous Integration/Continuous Deliver (“CI/CD”) tools and specifying a common set of parameters around the use of CI/CD tools, automation solutions (e.g., pipelines and associated artifacts) developed in vendor laboratories can be easily ported or promoted into service provider environments.

The concepts and technologies disclosed herein are directed to automated deployment and management of network functions in multi-vendor cloud networks. More particularly, the concepts and technologies disclosed herein provide a common method for automating deployment and management of a service provider's multi-vendor heterogeneous network using industry standard CI/CD methods and solutions, such as pipelines, code repository, image repository, secret management, and the like. The concepts and technologies disclosed herein allow service providers to build and manage such a network in an automated, cost-efficient, fast, repeatable, secure, and scalable way, to better serve business needs and to monetize the multi-vendor cloud network.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of systems, devices, computer-readable storage mediums, and methods for automated deployment and management of network functions in multi-vendor cloud networks will be described.

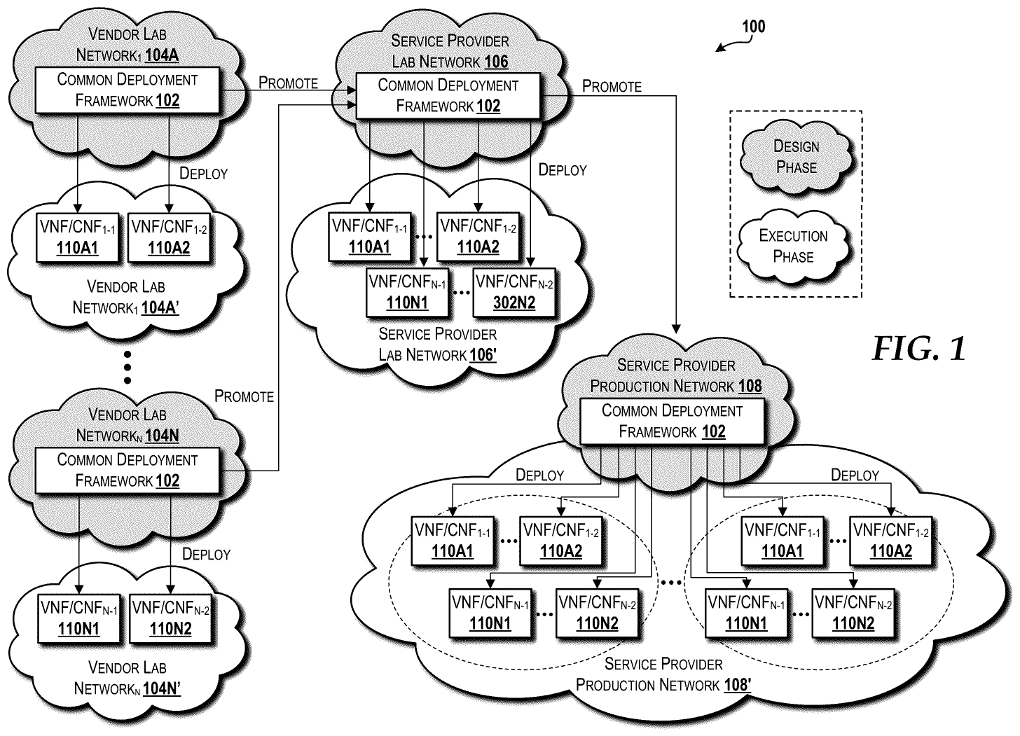

Turning now to FIG. 1, a block diagram illustrating an operating environment 100 in which the concepts and technologies disclosed herein can be implemented will be described in accordance with exemplary embodiments. The operating environment 100 includes a common deployment framework 102. The common deployment framework 102 can be defined by a service provider (e.g., a telecommunications service provider). The common deployment framework 102 can be implemented using industry standard continuous integration/continuous delivery (“CI/CD”) tools, such as, but not limited to, MICROSOFT AZURE DevOps or the like. Continuous integration (“CI”) is a software development practice where developers merge code changes into a shared code repository from which automated builds and tests can be run. CI enables software developers to debug quicker, improve software quality, and reduce the time between software validation and release. Continuous delivery (“CD”) is a software development practice where code changes are automatically prepared for a release to production. More particularly, CD expands upon CI by deploying code changes to a testing/design environment and/or to a production/execution environment after the software is built.

The common deployment framework 102 supports a service provider's business and operational needs in two phases—a design phase and an execution phase—across a plurality of vendor lab networks 104A-104N, a service provider lab network 106, and a service provider production network 108. In the illustrated example, elements of the operating environment 100 that operate as part of the design phase are represented in gray. These include the plurality of vendor lab networks_{1-N} 104A-104N (hereafter referred to collectively as “vendor lab networks 104” or individually as “vendor lab network 104”), the service provider lab network 106, and the service provider production network 108. Elements of the operating environment 100 that operate as part of the design phase are represented in white. These include the plurality of vendor lab networks_{1-N} 104A′-104N′ (hereafter referred to collectively as “vendor lab networks 104′” or individually as “vendor lab network 104”), the service provider lab network 106′, and the service provider production network 108′.

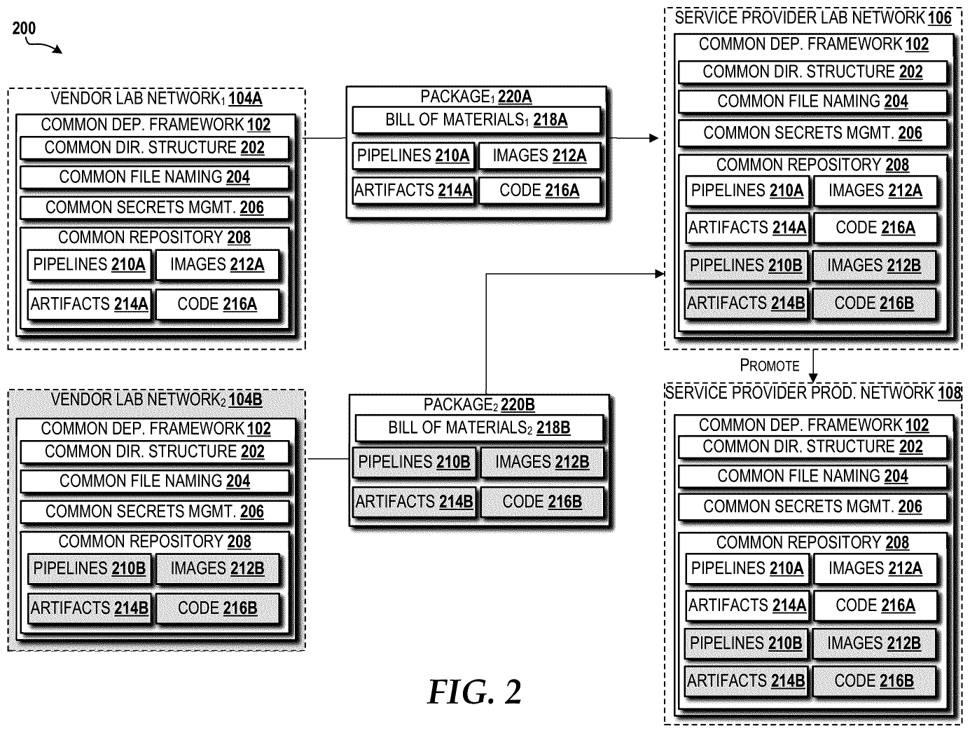

During the design phase, both a plurality of vendors associated with the vendor lab networks 104 and a service provider associated with both the service provider lab network 106 and the service provider production network 108 can perform design phase operations. Each vendor can provide, to the service provider, various items that encapsulate the logic and tools used to create and deploy one or more vendor-specific network functions, which are shown in FIG. 1 as virtual network functions or containerized network functions (“VNF/CNF”) 110. More particularly, the service provider can create, for the common deployment framework 102, a repository structure to hold pipelines and artifacts (best shown in FIG. 2), a repository to hold images and code that define the VNF/CNF 110, a secret management solution (e.g., store, transmit, and manage security authentication credentials), a schema to support necessary environment variable for a specific network function type, and to ensure that all repositories exhibit version control and change management behavior (as best practices). The common deployment framework 102 can easily be ported or promoted from the vendor lab environment (e.g., the vendor lab network 104) into the service provider lab environment (e.g., the service provider lab network 106), and eventually into the service provider production environment (e.g., the service provider production network 108).

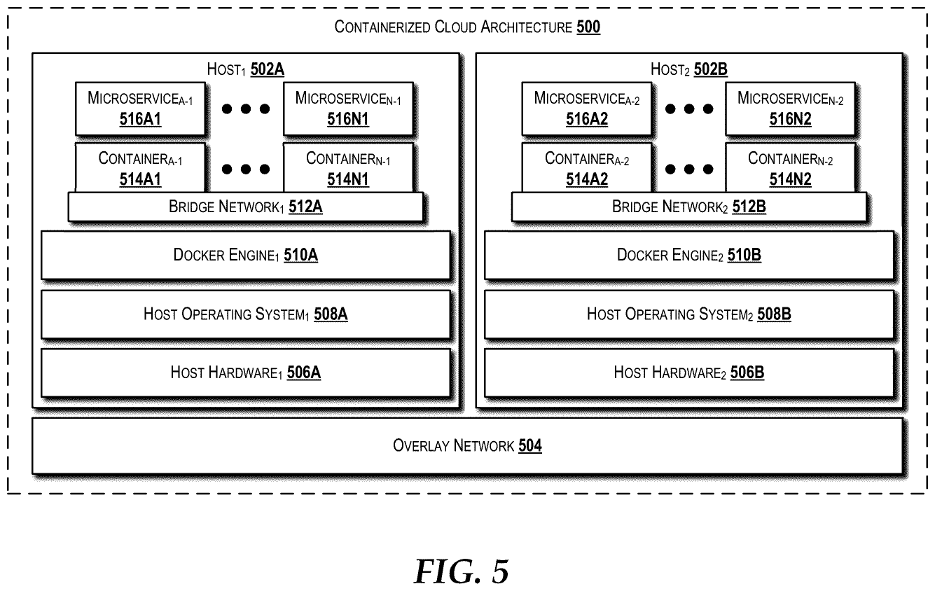

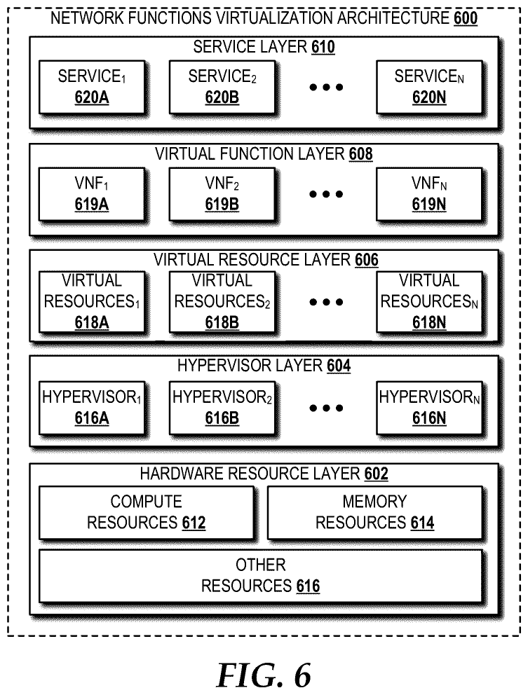

VNFs are software applications that implement network functions built on top of a network functions virtualization (“NFV”) architecture and deployed as virtual machines (“VM”). An example NFV architecture 600 is illustrated and described herein with reference to FIG. 6. CNFs package software network functions and any files necessary to run the network functions and share access to operating system and other resources. The CNFs can package a single network function or multiple network functions. The CNFs can include a decomposition of one or more network functions into a plurality of microservices. An example containerized cloud architecture 500 is illustrated and described herein with reference to FIG. 5. It should be understood that each VNF/CNF 110 shown in FIG. 1 is representative of a single VNF, a single CNF, or a combination of both a VNF and a CNF. Although VNFs and CNFs are described herein as example implementations of network functions, those skilled in the art will appreciate that other implementations of the network functions are applicable to the concepts and technologies disclosed herein.

The illustrated vendor lab networks 104A′ is associated with a first vendor and includes a VNF/CNF₁₋₁ 110A1 and a VNF/CNF₁₋₂ 110A2, and the illustrated vendor lab network 104N′ is associated with an N^{th} vendor and includes a VNF/CNF_{N-1} 110N1 and a VNF/CNF_{N-2} 110N2. Although each vendor lab network 104′ is shown with two VNF/CNFs 110, each vendor lab network 104′ may have any number of VNF/CNFs 110. Moreover, the network functions provided by the VNF/CNFs 110 can include any network function used to provide, at least in part, one or more services offered by the service provider. By way of example, and not limitation, the VNF/CNFs 110 can be used to implement, at least in part, a software-defined network (“SDN”) based telecommunications service, including voice and/or data services for mobile and/or landline telecommunications. It should be understood, however, that the concepts and technologies disclosed herein can be used to implement Software as a Service (“SaaS”), Backup as a Service (“BaaS”), Security as a Service (“SaaS”), Disaster Recovery as a Service (“DRaaS”), Desktop as a Service (“DaaS”), Infrastructure as a Service (“IaaS”), Platform as a Service (“PaaS”), other cloud services, combinations thereof, and/or the like. Moreover, those skilled in the art will find the concepts and technologies applicable to implementations of other services not explicitly mentioned herein.

During the execution phase, the service provider can create instance specific data to satisfy the schema required for a particular network function type either manually or using an automation solution. This can either be done in advance or can be done dynamically as part of the execution of the deployment process. The service provider can store the instance specific artifacts into the common deployment framework 102 defined in the design phase if prepared in advance. The common deployment framework 102 also can provide a graphical user interface (“GUI”)-based tool through which users (not shown) can perform deployment of the VNF/CNFs 110 using minimal input (e.g., one-click). In this manner, all the deployment-related technical details are hidden from the user.

Turning now to FIG. 2, a block diagram illustrating a logic architecture 200 for the common deployment framework 102 will be described, according to an illustrative embodiment. The logic architecture 200 illustrates the following logical functional blocks that compose the common deployment framework 102: a common directory structure 202, a common file naming convention 204, a common secrets management structure 206, and a common repository 208 that, in turn, includes one or more pipelines 210, one or more images 212, one or more artifacts 214, and code 216.

The pipelines 210 are parameterized to accept site specific data so they can be used in any deployment environment. The service provider can provide a database of site-specific information (not shown) that is merged with the generic, parameterized pipelines, to make the pipeline for a specific lab instance. The artifacts 214 are deployable components (e.g., of a larger application). The code 216 is the raw code used to create the artifacts 214. The images 312 can be or can include container images (e.g., DOCKER container images) or VM snapshots.

Once the deployment pipelines 210, artifacts 214, code 216, and images 212 are certified as generating the correct deployment for a VNF/CNF 110 in the service provider lab network 106, the package 220 of those items can be promoted into the service provider production network 108. The database of site-specific information can be merged with the now lab-certified generic, parameterized pipelines, to make the pipeline 210 for a specific production instance. Each lab and production site can have unique site-specific data. Common global variables can be used for all instances of a VNF/CNF 110 and also can be merged with parameterized pipelines in similar manner. Examples of global variables include timer values, performance parameters, and/or service parameters.

Specifying the common directory structure 202, the common file naming convention 204, and the common secrets management structure 206 across the vendor lab networks 104, the service provider lab network 106, and the service provider production network 108 enables the seamless promotion of the pipelines 210 and artifacts 214 across multiple network environments. Moreover, using the common repository 208 enables the seamless promotion of the pipelines 210 and the artifacts 214 across multiple network environments.

Each vendor can specify what they are delivering into the common deployment framework 102 in a bill of materials 218 that contains the pipelines 210, the images 212, the artifacts 214, and the code 216. The specification for the delivery VNF/CNF 110 is defined in a standard way and is machine processable. In the illustrated example, the vendor responsibility and deliverables are shown on the left side of FIG. 2. Although only two vendor lab networks 104A, 104B are shown, the common deployment framework 102 can be utilized by any number of vendors and any number of vendor lab networks 104. A first vendor associated with the vendor lab networks 104A packages the bill of materials' 218A and its contents as a package₁ 220A for delivery to the service provider lab network 106. Likewise, a second vendor associated with the vendor lab network₂ 104B packages the bill of materials₂ 218B and its contents as a package₂ 220B for delivery to the service provider lab network 106. With this design methodology, the service provider can leverage each vendor's domain expertise to deliver their own network function automation in a way that plugs into the service provider's methodology and framework. In addition, vendors can develop their solution independently and in parallel. This improves the speed of the overall deployment solution implementation lifecycle.

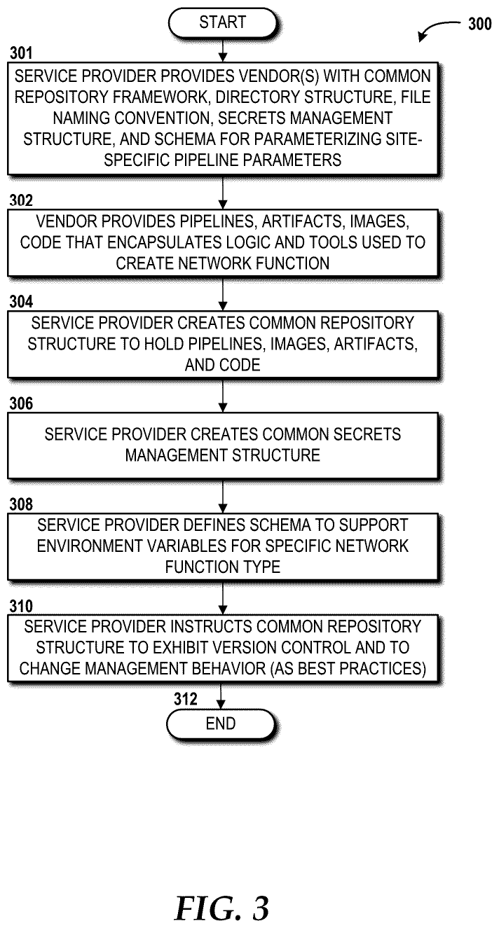

Turning now to FIG. 3, a method 300 for implementing the common deployment framework 102 during a design phase will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device to perform one or more operations, and/or causing the processor to direct other components of the computing system or device to perform one or more of the operations.

For purposes of illustrating and describing the concepts of the present disclosure, operations of the methods disclosed herein are described as being performed by a service provider system, which can be implemented, at least in part, as part of NFV architecture 600, a containerized cloud architecture 500, and/or a computer system 700. It should be understood that additional and/or alternative devices, servers, computers, and/or network nodes can provide the functionality described herein via execution of one or more modules, applications, and/or other software. Thus, the illustrated embodiments are illustrative, and should not be viewed as being limiting in any way.

The method 300 begins and proceeds to operation 301. At operation 301, the service provider provides the vendor(s) with a common/defined repository framework, directory structure, file naming convention, secret management structure, and schema for parameterizing site-specific pipeline parameters. From operation 301, the method 300 proceeds to operation 302. At operation 302, a vendor, such as a vendor associated with the vendor lab network 104, can provide the pipelines 210, artifacts 214, images 212, and code 216 that encapsulate the logic and tools used to create a network function, such as the VNF/CNF 110. From operation 302, the method 300 proceeds to operation 304. At operation 304, the service provider, via a service provider system, creates the common repository 208 to hold the pipelines 210, the images 212, the artifacts 214, and the code 216 for the VNF/CNF 110 that the vendor wants to create. From operation 304, the method 300 proceeds to operation 306. At operation 306, the service provider, via the service provider system, creates the common secrets management structure 206. From operation 306, the method 300 proceeds to operation 308. At operation 308, the service provider, via the service provider system, defines the schema to support environment variables for the specific network function type of the VNF/CNF 110. From operation 308, the method 300 proceeds to operation 310. At operation 310, the service provider, via the service provider system, instructs the common repository 208 to exhibit version control and to change management behavior (as best practices). From operation 310, the method 300 proceeds to operation 312. The method 300 can end at operation 312.

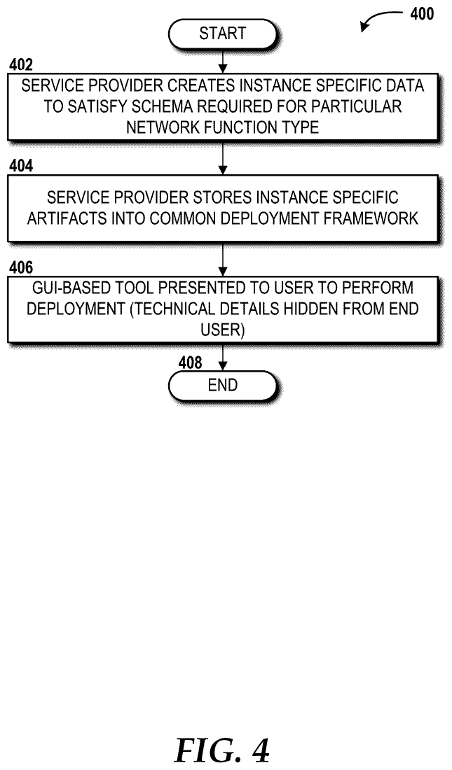

Turning now to FIG. 4, a method 400 for implementing the common deployment framework 102 during an execution phase will be described, according to an illustrative embodiment. The method 400 begins and proceeds to operation 402. At operation 402, the service provider, via a service provider system, creates instance specific data to satisfy the schema (defined at operation 308 in the method 300) for the particular network function type of the VNF/CNF 110. The instance specific data can be created manually or via an automated solution. In some embodiments, the operation 402 can be performed in advance. In other embodiments, the operation 402 can be performed dynamically as part of the execution phase of the deployment process. From operation 402, the method 400 proceeds to operation 404. At operation 404, the service provider, via the service provider system, stores the instance specific artifacts 214 into the common deployment framework 102 (if the artifacts 214 are prepared in advance as part of the design phase). From operation 404, the method 400 proceeds to operation 406. At operation 406, the service provider, via the service provider system, presents a GUI-based tool through which users can perform deployment of the request VNF/CNF 110. From operation 406, the method 400 proceeds to operation 408. The method 400 can end at operation 408.

Turning now to FIG. 5, a block diagram illustrating an exemplary containerized cloud architecture 500 capable of implementing, at least in part, aspects of the concepts and technologies disclosed herein will be described, according to an illustrative embodiment. The containerized cloud architecture 500 can be implemented, at least in part, by the vendor lab networks 104, the service provider lab network 106, the service provider production network 108, or by some combination thereof. Moreover, aspects of the methods 300, 400 performed by a service provider system can be performed, at least in part, by the containerized cloud architecture 500.

The illustrated containerized cloud architecture 500 includes a first host (“host₁”) 502A and a second host (“host₂”) 502B (at times referred to herein collectively as hosts 502 or individually as host 502) that can communicate via an overlay network 504. Although two hosts 502 are shown, the containerized cloud architecture 500 can support any number of hosts 502. The containerized cloud architecture 500 can be utilized by any number of networks described herein, including, for example the vendor lab networks 104, the service provider lab network 106, the service provider production network 108, or some combination thereof. The overlay network 504 can enable communication among hosts 502 in the same cloud network or hosts 502 across different cloud networks. Moreover, the overlay network 504 can enable communication among hosts 502 owned and/or operated by the same or different entities.

The illustrated host 502A includes a host hardware₁ 506A, a host operating system₁ 508A, a DOCKER engine₁ 510A, a bridge network₁ 512A, container_{A-1} through container_{N-1} 514A1-514N1, and microservice_{A-1} through microservice_{N-1} 516A1-516N1. Similarly, the illustrated host₂ 502B includes a host hardware₂ 506B, a host operating system₂ 508B, a DOCKER engine₂ 510B, a bridge network₂ 512B, container_{A-2} through container_{N-2} 514A2-514N2, and microservice_{A-2} through microservice_{N-2} 516A2-516N2.

The host hardware₁ 506A and the host hardware₂ 506B (at times referred to herein collectively or individually as host hardware 506) can be implemented as bare metal hardware such as one or more physical servers. The host hardware 506 alternatively can be implemented using hardware virtualization. In some embodiments, the host hardware 506 can include compute resources, memory resources, and other hardware resources. These resources can be virtualized according to known virtualization techniques. A network functions virtualization architecture 600 is described herein with reference to FIG. 6. Although the containerized cloud architecture 500 and the network functions virtualization architecture 600 are described separately, these architectures can be combined to provide a hybrid containerized/virtualized cloud architecture. Those skilled in the art will appreciate that the disclosed cloud architectures are simplified for ease of explanation and can be altered as needed for any given implementation without departing from the scope of the concepts and technologies disclosed herein. As such, the containerized cloud architecture 500 and the network functions virtualization architecture 600 should not be construed as being limiting in any way.

Compute resources can include one or more hardware components that perform computations to process data and/or to execute computer-executable instructions. For example, the compute resources can execute instructions of the host operating system₁ 508A and the host operating system₂ 508B (at times referred to herein collectively as host operating systems 508 or individually as host operating system 508), the containers 514A1-514N1 and the containers 514A2-514N2 (referred to collectively as “containers 514” or individually as “container 514”), and the microservices 516A1-516N1 and the microservices 516A2-516N2 (referred to collectively as “microservices 516” or individually as “microservice 516”).

The compute resources of the host hardware 506 can include one or more central processing units (“CPUs”) configured with one or more processing cores. The compute resources can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources can include one or more discrete GPUs. In some other embodiments, the compute resources can include CPU and GPU components that are configured in accordance with a co-processing CPU/GPU computing model, wherein the sequential part of an application executes on the CPU and the computationally-intensive part is accelerated by the GPU. The compute resources can include one or more system-on-chip (“SoC”) components along with one or more other components, including, for example, one or more memory resources, and/or one or more other resources. In some embodiments, the compute resources can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources can be or can include one or more hardware components architected in accordance with an advanced reduced instruction set computing (“RISC”) (“ARM”) architecture, available for license from ARM HOLDINGS. Alternatively, the compute resources can be or can include one or more hardware components architected in accordance with an x86 architecture, such an architecture available from INTEL CORPORATION, and others. Those skilled in the art will appreciate the implementation of the compute resources can utilize various computation architectures, and as such, the compute resources should not be construed as being limited to any particular computation architecture or combination of computation architectures, including those explicitly disclosed herein.

The memory resources of the host hardware 506 can include one or more hardware components that perform storage operations, including temporary or permanent storage operations. In some embodiments, the memory resource(s) include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources.

The other resource(s) of the host hardware 506 can include any other hardware resources that can be utilized by the compute resources(s) and/or the memory resource(s) to perform operations described herein. The other resource(s) can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The host operating systems 508 can be proprietary, open source, or closed source. In some embodiments, the host operating systems 508 can be or can include one or more container operating systems designed specifically to host containers such as the containers 514. For example, the host operating systems 508 can be or can include FEDORA COREOS (available from RED HAT, INC), RANCHEROS (available from RANCHER), and/or BOTTLEROCKET (available from Amazon Web Services). In some embodiments, the host operating systems 508 can be or can include one or more members of the WINDOWS family of operating systems from MICROSOFT CORPORATION (e.g., WINDOWS SERVER), the LINUX family of operating systems (e.g., CENTOS, DEBIAN, FEDORA, ORACLE LINUX, RHEL, SUSE, and UBUNTU), the SOLARIS family of operating systems from ORACLE CORPORATION, other operating systems, and the like.

The containerized cloud architecture 500 can be implemented utilizing any containerization technologies. Presently, open-source container technologies, such as those available from DOCKER, INC., are the most widely used, and it appears will continue to be for the foreseeable future. For this reason, the containerized cloud architecture 500 is described herein using DOCKER container technologies available from DOCKER, INC., such as the DOCKER engines 510. Those skilled in the art will appreciate that other container technologies may also be applicable to implementing the concepts and technologies disclosed herein, and as such, the containerized cloud architecture 500 is not limited to DOCKER container technologies. Moreover, although open-source container technologies are most widely used, the concepts and technologies disclosed here may be implemented using proprietary technologies or closed source technologies.

The DOCKER engines 510 are based on open source containerization technologies available from DOCKER, INC. The DOCKER engines 510 enable users (not shown) to build and containerize applications. The full breadth of functionality provided by the DOCKER engines 510 and associated components in the DOCKER architecture are beyond the scope of the present disclosure. As such, the primary functions of the DOCKER engines 510 will be described herein in brief, but this description should not be construed as limiting the functionality of the DOCKER engines 510 or any part of the associated DOCKER architecture. Instead, those skilled in the art will understand the implementation of the DOCKER engines 510 and other components of the DOCKER architecture to facilitate building and containerizing applications within the containerized cloud architecture 500.

The DOCKER engine 510 functions as a client-server application executed by the host operating system 508. The DOCKER engine 510 provides a server with a daemon process along with application programming interfaces (“APIs”) that specify interfaces that applications can use to communicate with and instruct the daemon to perform operations. The DOCKER engine 510 also provides a command line interface (“CLI”) that uses the APIs to control and interact with the daemon through scripting and/or CLI commands. The daemon can create and manage objects such as images, containers, networks, and volumes. Although a single DOCKER engine 510 is illustrated in each of the hosts 502, multiple DOCKER engines 510 are contemplated. The DOCKER engine(s) 510 can be run in swarm mode.

The bridge networks 512 enable the containers 514 connected to the same bridge network to communicate. For example, the bridge network₁ 512A enables communication among the containers 514A1-514N1, and the bridge network₂ 512B enables communication among the containers 514A2-514N2. In this manner, the bridge networks 512 isolate the containers 514A1-514N1 from the containers 514A2-514N2 to prevent direct communication. In some embodiments, the bridge networks 512 are software network bridges implemented via the DOCKER bridge driver. The DOCKER bridge driver enables default and user-defined network bridges.

The containers 514 are runtime instances of images, such as the images 212 (best shown in FIG. 2). The containers 514 are described herein specifically as DOCKER containers, although other containerization technologies are contemplated as noted above. Each container 514 can include an image, an execution environment, and a standard set of instructions.

The microservices 516 are applications that provide a single function. In some embodiments, each of the microservices 516 is provided by one of the containers 514, although each of the containers 514 may contain multiple microservices 516. For example, the microservices 516 can include, but are not limited, to services associated with the CNF of the VNF/CNF 110 to be run in an execution environment provided by a container 514. The microservices 516 can provide any type of functionality, and therefore all the possible functions cannot be listed herein. Those skilled in the art will appreciate the use of the microservices 516 along with the containers 514 to improve many aspects of the containerized cloud architecture 500, such as reliability, security, agility, and efficiency, for example.

Turning now to FIG. 6, a block diagram illustrating an example NFV architecture 600 and components thereof will be described, according to an exemplary embodiment. The NFV architecture 600 can be utilized to implement various elements disclosed herein. For example, the NFV architecture 600 can be utilized to virtualize components of the hosts 502, such as the virtualization of the host hardware 506. The NFV architecture 600 also can be utilized to virtualize components of the VNF/CNFs 110. The NFV architecture 600 can be implemented, at least in part, by the vendor lab networks 104, the service provider lab network 106, the service provider production network 108, or by some combination thereof. Moreover, aspects of the methods 300, 400 performed by a service provider system can be performed, at least in part, by the NFV architecture 600.

The NFV architecture 600 includes a hardware resource layer 602, a hypervisor layer 604, a virtual resource layer 606, a virtual function layer 608, and a service layer 610. While no connections are shown between the layers illustrated in FIG. 6, it should be understood that some, none, or all of the components illustrated in FIG. 6 can be configured to interact with one other to carry out various functions described herein. In some embodiments, the components are arranged so as to communicate via one or more networks. Thus, it should be understood that FIG. 6 and the remaining description are intended to provide a general understanding of a suitable environment in which various aspects of the embodiments described herein can be implemented and should not be construed as being limiting in any way.

The hardware resource layer 602 provides hardware resources. In the illustrated embodiment, the hardware resource layer 602 includes one or more compute resources 612, one or more memory resources 614, and one or more other resources 616. The compute resource(s) 612 can include one or more hardware components that perform computations to process data and/or to execute computer-executable instructions of one or more application programs, one or more operating systems, and/or other software. In particular, the compute resources 612 can include one or more central processing units (“CPUs”) configured with one or more processing cores. The compute resources 612 can include one or more graphics processing unit (“GPU”) configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the compute resources 612 can include one or more discrete GPUs. In some other embodiments, the compute resources 612 can include CPU and GPU components that are configured in accordance with a co-processing CPU/GPU computing model, wherein the sequential part of an application executes on the CPU and the computationally-intensive part is accelerated by the GPU processing capabilities. The compute resources 612 can include one or more system-on-chip (“SoC”) components along with one or more other components, including, for example, one or more of the memory resources 614, and/or one or more of the other resources 616. In some embodiments, the compute resources 612 can be or can include one or more SNAPDRAGON SoCs, available from QUALCOMM of San Diego, California; one or more TEGRA SoCs, available from NVIDIA of Santa Clara, California; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Texas; one or more customized versions of any of the above SoCs; and/or one or more proprietary SoCs. The compute resources 612 can be or can include one or more hardware components architected in accordance with an ARM architecture, available for license from ARM HOLDINGS of Cambridge, United Kingdom. Alternatively, the compute resources 612 can be or can include one or more hardware components architected in accordance with an x86 architecture, such an architecture available from INTEL CORPORATION of Mountain View, California, and others. Those skilled in the art will appreciate the implementation of the compute resources 612 can utilize various computation architectures, and as such, the compute resources 612 should not be construed as being limited to any particular computation architecture or combination of computation architectures, including those explicitly disclosed herein.

The memory resource(s) 614 can include one or more hardware components that perform storage/memory operations, including temporary or permanent storage operations. In some embodiments, the memory resource(s) 614 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 612.

The other resource(s) 616 can include any other hardware resources that can be utilized by the compute resources(s) 612 and/or the memory resource(s) 614 to perform operations described herein. The other resource(s) 616 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 602 can be virtualized by one or more hypervisors 618A-618N (also known as “virtual machine monitors”) operating within the hypervisor layer 604 to create virtual resources that reside in the virtual resource layer 606. The hypervisors 618A-618N can be or can include software, firmware, and/or hardware that alone or in combination with other software, firmware, and/or hardware, creates and manages virtual resources 620A-620N operating within the virtual resource layer 606.

The virtual resources 620A-620N operating within the virtual resource layer 1406 can include abstractions of at least a portion of the compute resources 612, the memory resources 614, and/or the other resources 616, or any combination thereof. In some embodiments, the abstractions can include one or more VMs, virtual volumes, virtual networks, and/or other virtualized resources upon which one or more VNFs 622A-622N can be executed, such as the VNF/CNFs 110. The VNFs 622A-622N in the virtual function layer 608 are constructed out of the virtual resources 620A-620N in the virtual resource layer 606. In the illustrated example, the VNFs 622A-622N can provide, at least in part, one or more services 624A-624N, such as telecommunications services, in the service layer 610.

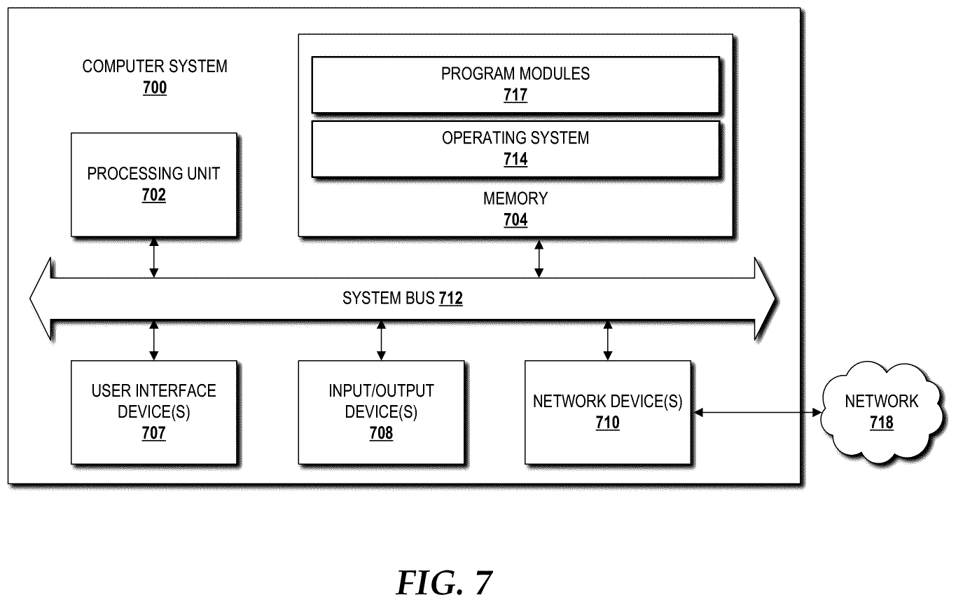

Turning now to FIG. 7, a block diagram illustrating a computer system 700 configured to provide the functionality described herein in accordance with various embodiments of the concepts and technologies disclosed herein. In some embodiments, the service provider system can be configured like and/or can have an architecture similar or identical to the computer system 700 described herein with respect to FIG. 7. It should be understood, however, that any of these systems, devices, or elements may or may not include the functionality described herein with reference to FIG. 7.

The computer system 700 includes a processing unit 702, a memory 704, one or more user interface devices 706, one or more input/output (“I/O”) devices 708, and one or more network devices 710, each of which is operatively connected to a system bus 712. The bus 712 enables bi-directional communication between the processing unit 702, the memory 704, the user interface devices 706, the I/O devices 708, and the network devices 710.

The processing unit 702 may be a standard central processor that performs arithmetic and logical operations, a more specific purpose programmable logic controller (“PLC”), a programmable gate array, or other type of processor known to those skilled in the art and suitable for controlling the operation of the computer system 700.

The memory 704 communicates with the processing unit 702 via the system bus 712. In some embodiments, the memory 704 is operatively connected to a memory controller (not shown) that enables communication with the processing unit 702 via the system bus 712. The memory 704 includes an operating system 714 and one or more program modules 716. The operating system 714 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 716 may include various software and/or program modules described herein. By way of example, and not limitation, computer-readable media may include any available computer storage media or communication media that can be accessed by the computer system 700. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 700. In the claims, the phrase “computer storage medium,” “computer-readable storage medium,” and variations thereof does not include waves or signals per se and/or communication media, and therefore should be construed as being directed to “non-transitory” media only.

The user interface devices 706 may include one or more devices with which a user accesses the computer system 700. The user interface devices 706 may include, but are not limited to, computers, servers, personal digital assistants, cellular phones, or any suitable computing devices. The I/O devices 708 enable a user to interface with the program modules 716. In one embodiment, the I/O devices 708 are operatively connected to an I/O controller (not shown) that enables communication with the processing unit 702 via the system bus 712. The I/O devices 708 may include one or more input devices, such as, but not limited to, a keyboard, a mouse, or an electronic stylus. Further, the I/O devices 708 may include one or more output devices, such as, but not limited to, a display screen or a printer to output data.

The network devices 710 enable the computer system 700 to communicate with other networks or remote systems via one or more networks, such as a network 718. Examples of the network devices 710 include, but are not limited to, a modem, a RF or infrared (“IR”) transceiver, a telephonic interface, a bridge, a router, or a network card. The network(s) may include a wireless network such as, but not limited to, a wireless local area network (“WLAN”) such as a WI-FI network, a wireless wide area network (“WWAN”), a Wireless Personal Area Network (“WPAN”) such as BLUETOOTH, a wireless metropolitan area network (“WMAN”) such a WiMAX network, or a cellular network. Alternatively, the network(s) may be a wired network such as, but not limited to, a WAN such as the Internet, a LAN, a wired PAN, or a wired MAN.

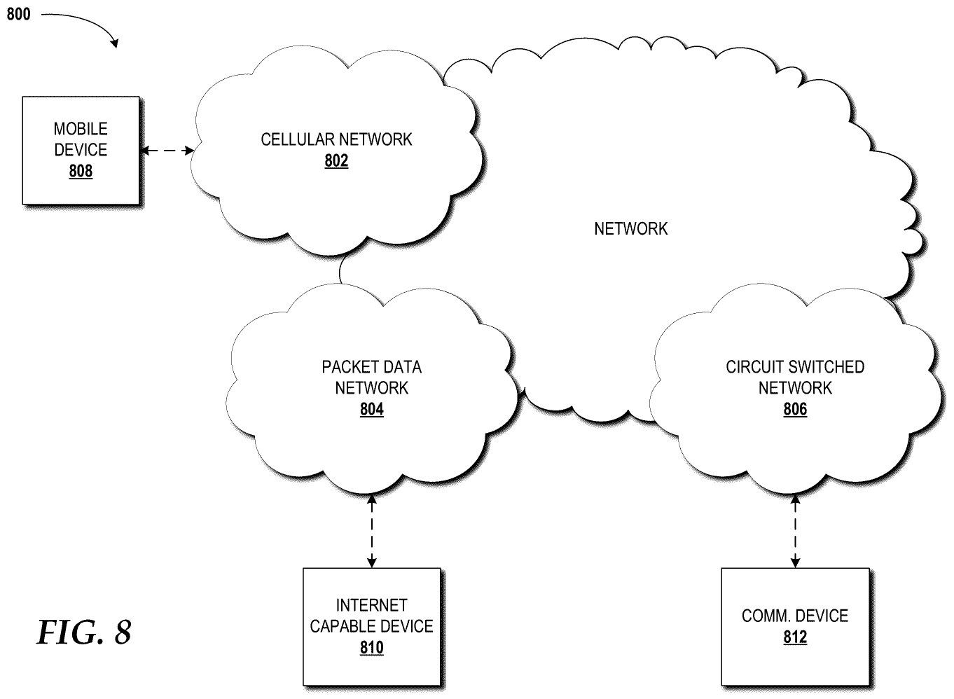

Turning now to FIG. 8, a network 800 is illustrated, according to an illustrative embodiment. Communications among the vendor lab network(s) 104, the service provider lab network 106, and the service provider production network 108 can be handled over at least a portion of the network 800. The illustrated network 800 includes a cellular network 802 (e.g., mobile network), a packet data network 804, for example, the Internet, and a circuit switched network 806, for example, a publicly switched telephone network (“PSTN”). The cellular network 802 includes various components such as, but not limited to, base transceiver stations (“BTSs”), Node-B's, e-Node-B's, g-Node-B's base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 802 also includes radios and nodes for receiving and transmitting voice, data, and combinations thereof to and from radio transceivers, networks, the packet data network 804, and the circuit switched network 806.

A mobile communications device 808, such as, for example, a cellular telephone, a user equipment, a mobile terminal, a PDA, a laptop computer, a handheld computer, and combinations thereof, can be operatively connected to the cellular network 802. The mobile communications device 808 can be operatively connected to the cellular network 802. The cellular network 802 can be configured as a 2G GSM network and can provide data communications via GPRS and/or EDGE. Additionally, or alternatively, the cellular network 802 can be configured as a 3G UMTS network and can provide data communications via the HSPA protocol family, for example, HSDPA, EUL (also referred to as HSUPA), and HSPA+. The cellular network 802 also is compatible with 4G and 5G mobile communications standards as well as evolved and future mobile standards.

The packet data network 804 includes various devices in communication with another, as is generally known. The packet data network 804 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 804 includes or is in communication with the Internet.

The circuit switched network 806 includes various hardware and software for providing circuit switched communications. The circuit switched network 806 may include, or may be, what is often referred to as a plain old telephone system (“POTS”). The functionality of a circuit switched network 806 or other circuit-switched network are generally known and will not be described herein in detail.

The illustrated cellular network 802 is shown in communication with the packet data network 804 and a circuit switched network 806, though it should be appreciated that this is not necessarily the case. One or more Internet-capable devices 810, for example, a personal computer (“PC”), a laptop, a portable device, or another suitable device, can communicate with one or more cellular networks 802, and devices connected thereto, through the packet data network 804. It also should be appreciated that the Internet-capable device 810 can communicate with the packet data network 804 through the circuit switched network 806, the cellular network 802, and/or via other networks (not illustrated).

As illustrated, a communications device 812, for example, a telephone, facsimile machine, modem, computer, or the like, can be in communication with the circuit switched network 806, and therethrough to the packet data network 804 and/or the cellular network 802. It should be appreciated that the communications device 812 can be an Internet-capable device, and can be substantially similar to the Internet-capable device 810.

Based on the foregoing, it should be appreciated that aspects of automated deployment and management of network functions in multi-vendor cloud networks have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
creating, by a service provider system comprising a processor, at least one repository structure to hold at least one pipeline, at least one artifact, at least one image, and code used to create a network function;
creating, by the service provider system, a secrets management structure for the network function;
defining, by the service provider system, a schema to support environment variables for a network function type of the network function; and
instructing, by the service provider system, the at least one repository structure to exhibit version control and change management behavior.

2. The method of claim 1, further comprising:
creating, by the service provider system, instance specific data to satisfy the schema required for the network function type;
storing, by the service provider system, the at least one artifact into a framework defined during a design phase.

3. The method of claim 2, further comprising presenting a graphical user interface-based tool through which a user can instruct the service provider system to deploy the network function.

4. The method of claim 3, further comprising receiving a package comprising a bill of materials, the at least one pipeline, the at least one artifact, the at least one image, and the code.

5. The method of claim 4, wherein the network function comprises a virtual network function.

6. The method of claim 4, wherein the network function comprises a containerized network function.

7. The method of claim 4, wherein receiving the package comprises receiving the package from a vendor.

8. The method of claim 7, further comprising promoting the network function from a service provider lab site to a service provider production site.

9. An system comprising:
a processor; and
a memory comprising instructions that, when executed by the processor, cause the processor to perform operations comprising
creating at least one repository structure to hold at least one pipeline, at least one artifact, at least one image, and code used to create a network function,
creating a secret management solution for the network function;
defining a schema to support environment variables for a network function type of the network function, and
instructing the at least one repository structure to exhibit version control and change management behavior.

10. The system of claim 9, wherein the operations further comprise:
creating instance specific data to satisfy the schema required for the network function type;
storing the at least one artifact into a framework defined during a design phase.

11. The system of claim 10, wherein the operations further comprise presenting a graphical user interface-based tool through which a user can instruct the system to deploy the network function.

12. The system of claim 11, wherein the operations further comprise receiving a package comprising a bill of materials, the at least one pipeline, the at least one artifact, the at least one image, and the code.

13. The system of claim 12, wherein the network function comprises a virtual network function.

14. The system of claim 12, wherein the network function comprises a containerized network function.

15. The system of claim 12, wherein receiving the package comprises receiving the package from a vendor.

16. The system of claim 9, wherein the operations further comprise promoting the network function from a service provider lab site to a service provider production site.

17. A computer storage medium comprising computer-executable instructions that, when executed by a processor of a service provider system, cause the processor to perform operations comprising:
creating at least one repository structure to hold at least one pipeline, at least one artifact, at least one image, and code used to create a network function;
creating a secret management solution for the network function;
defining a schema to support environment variables for a network function type of the network function; and
instructing the at least one repository structure to exhibit version control and change management behavior.

18. The computer storage medium of claim 17, wherein the operations further comprise:
creating instance specific data to satisfy the schema required for the network function type; and
storing the at least one artifact into a framework defined during a design phase.

19. The computer storage medium of claim 17, wherein the operations further comprise presenting a graphical user interface-based tool through which a user can instruct the service provider system to deploy the network function.

20. The computer storage medium of claim 19, wherein the operations further comprise receiving, from a vendor, a package comprising a bill of materials, the at least one pipeline, the at least one artifact, the at least one image, and the code.
